(19) United States
(12) Patent Application Publication
(10) Pub. No.: US 2017/0339850 A1
(43) Pub. Date: Nov. 30, 2017

(54) Method of growing grapes

(71) Applicant: NZ TUBE MILLS LIMITED, LOWER HUTT (NZ)

(72) Inventor: PAUL BARNES, LOWER HUTT (NZ)

(73) Assignee: NZ TUBE MILLS LIMITED, LOWER HUTT (NZ)

(21) Appl. No.: 15/488,473

(22) Filed: Apr. 15, 2017

(30) Foreign Application Priority Data
May 26, 2016 (NZ) 720548

(51) Int. Cl. A01G 17/02; A01G 17/10; A01G 17/00

(52) U.S. Cl. CPC A01G 17/02; A01G 17/005; A01G 17/10

(57) ABSTRACT

A method of growing grapes comprising fitting a plurality of longitudinal sleeves to posts, respectively, each sleeve having at least one retainer; attaching at least two lines so that they are held by the retainers in an elevated disposition so that the lines at least partially support a grape vine; mechanically removing the lines from the retainers after harvesting grapes, each sleeve being secured to its respective post by fixing means so that the sleeves remain fitted to the posts when the line is being mechanically removed; pruning parts of the grape vine that remain with the lines when they are removed; and reattaching the lines so that they are again held by the retainers in an elevated disposition for further use.

### FIELD OF INVENTION

This invention relates to a method of growing grapes. A preferred form of the invention utilises a support arrangement for wires used for supporting vines, although it should be understood that the invention is not limited to this.

### BACKGROUND

It is known for a vineyard to use posts to hold a series of wires in an elevated fashion. The wires are used for supporting vines as they grow. A problem in some vineyards is that the wires attach to the posts directly and can be difficult to remove to facilitate pruning the vines. Also, in cases where a mechanical automatic pruning machine is used, if a wire is inadvertently not removed from its post prior to work by the machine then the wire can cause machine jams or lead to the post being pulled out of the ground. It is an object of a preferred form of the invention to go at least some way towards addressing these problems. While this applies to the preferred embodiment, it should be understood that the object of the invention per se is simply to provide the public with a useful choice. The object of the preferred embodiment should not be seen as a limitation of any claims that do not address that object.

### SUMMARY OF THE INVENTION

A method of growing grapes comprising the steps of:
a) fitting a plurality of longitudinal sleeves to posts, respectively, each sleeve having at least one retainer;
b) attaching at least two lines so that they are held by the retainers in an elevated disposition so that the lines at least partially support a grape vine;
c) mechanically removing the lines from the retainers after harvesting grapes, each sleeve being secured to its respective post by fixing means so that the sleeves remain fitted to the posts when the line is being mechanically removed;
d) pruning parts of the grape vine that remain with the lines when they are removed; and
e) reattaching the lines so that they are again held by the retainers in an elevated disposition for further use.

Optionally each fixing means is distinct from its respective post.

Optionally each fixing means comprises a fixing hole in each sleeve, and at least one fixing member arranged to pass through the hole and an opening in the post, to prevent the sleeve from being unintentionally removed upwardly from its corresponding post.

Optionally each sleeve has a plurality of the retainers.

Optionally the retainer, or each retainer as the case may be, comprises a clip.

Optionally the retainer, or each retainer, comprises upwardly extending resilient arms and the line held in a tension fit in a space between the arms.

Optionally the arms release grip on the line if the line is subjected to at least a 20 kg upward force.

Optionally the retainer, or each retainer as the case may be, is secured in an aperture of the sleeve.

Optionally the sleeve is substantially metallic, except for the retainer or retainers, which are substantially made of plastic.

Optionally the retainer, or each retainer as the case may be, is removable from each sleeve.

Optionally the line comprises wire.

Optionally each sleeve has a constricted upper region or an at least partially closed top to assist in retaining each sleeve at the desired height on its corresponding post.

### BRIEF DESCRIPTION OF DRAWINGS

Some preferred embodiments of the invention will now be described by way of example and with reference to the accompanying drawings and images, of which:

FIG. 1 is a perspective view of a trellis component comprising a sleeve with clips fitted to a post;

FIG. 2 is a front view of the component;

FIG. 3 is a perspective view of the sleeve;

FIG. 4 is a front view of the sleeve;

FIG. 5 is a side view of the sleeve; and

FIG. 6 is a perspective, cutaway, partial view of the component.

### DETAILED DESCRIPTION

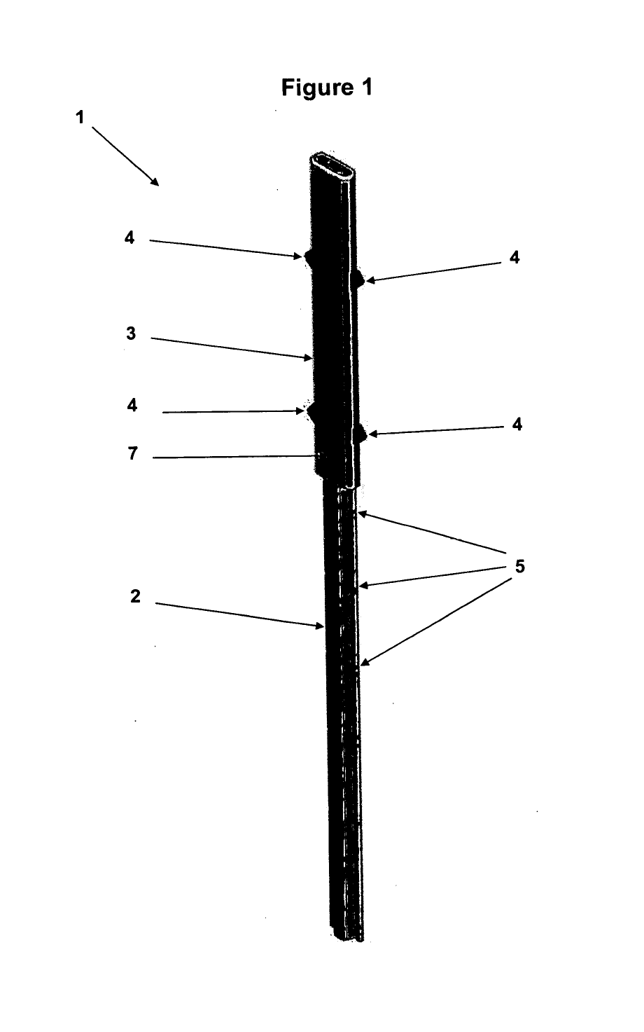

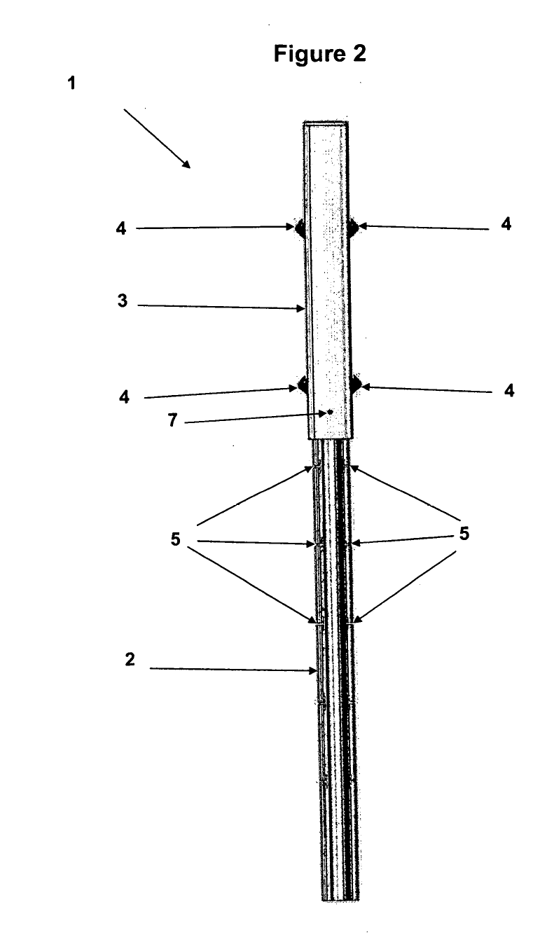

Referring to FIGS. 1 and 2, a trellis component 1 comprises a post 2, a longitudinal sleeve 3, and a plurality of clips 4.

The post 2 is designed for use in a vineyard and a plurality of the posts are spaced equally and arranged in a row to form a trellis for growing grapes. The trellis may also have other horticultural applications, for example for growing berries or stone fruits. The post 2 and sleeve 3 are each made of a suitable metallic substance, preferably galvanised steel, although they could be made of other materials, for example plastic. The clip 4 is made of plastic or a suitable alternative material.

Traditionally, vineyard posts are used without the sleeve 3 and clips. In the traditional practice, each post 2 may have at least one recess 5 for retaining a wire, also known as a crop line or fruiting wire (not shown). A row of posts supports a series of wires at differing heights. One wire is placed within the recess 5 of each post 2 at the corresponding height on each post 2, and the wire runs along the row of posts parallel to the ground. There will usually be more than one wire running along the row, for example two or three wires. Grape vines grow along the wires. At the end of the grape growing season the grapes are harvested. The vines then need to be pruned back in readiness for the next growing season.

Traditionally, when it is time to prune the vines, the wire needs to be removed from each recess 5 to enable end parts of the vines to be cut and removed from the wire. This usually needs to be done by hand, and it can be difficult to remove the wire from each recess 5. This process can be time consuming, in particular for large vineyards comprising multiple rows of trellises. The trellis component 1 aims to increase efficiency by reducing the time needed to prune vines.

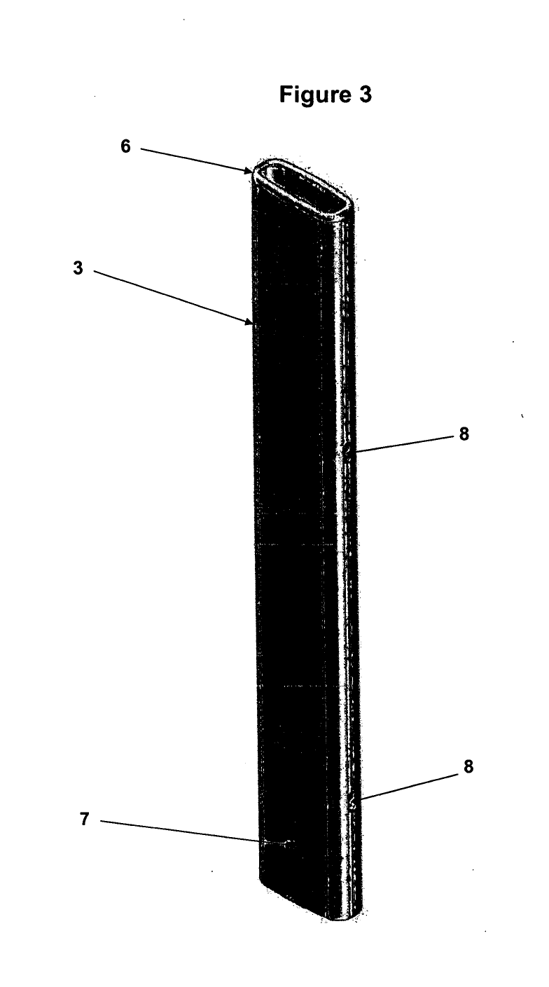

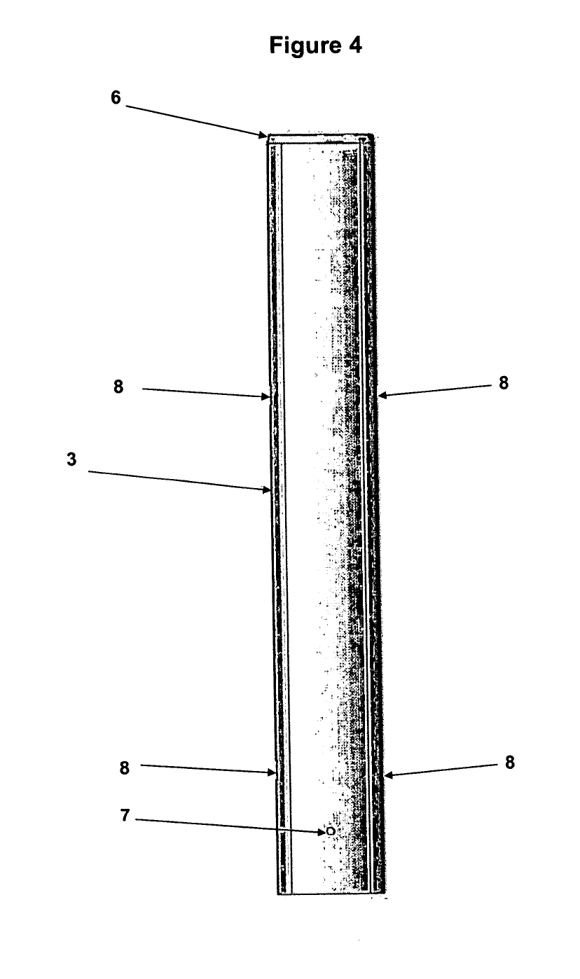

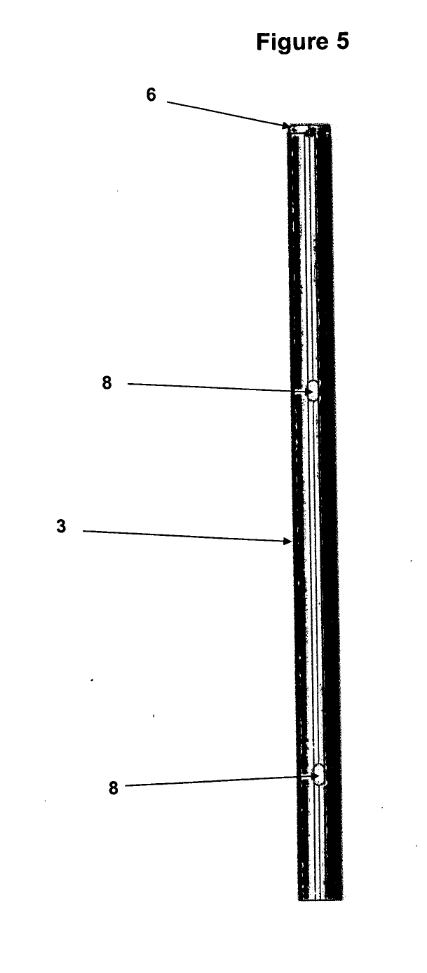

In preferred embodiments of the invention, for vineyards where posts are already installed in rows, each post 2 can be retrofitted with the sleeve 3. The sleeve 3 is dimensioned so that it can be slid over a top of the post 2 in a snug fit. The sleeve 3 can be seen in more detail in FIGS. 3 to 5. The sleeve 3 has a rolled top 6 which forms a lip that sits on or over a top edge of the post 2 to prevent the sleeve from sliding further down the post 2. Alternatively the top of the sleeve can be partially or fully crimped or otherwise closed to keep the sleeve at an upper part of the post 2.

The sleeve has a fixing hole 7 through which a pin or other fixing component, for example a screw (not shown), passes through an opening made in the post 2 to hold the sleeve 3 in place.

The sleeve 3 has at least one aperture 8 on each side. In the preferred embodiment shown in FIGS. 3 to 5 there are two apertures on each side, although there may be more or less, for example one or three. Each aperture 8 is adapted to receive and hold one of the clips 4. Each clip 4 has a base (not shown) that is adapted to pass through the aperture 4 whereupon the clip 4 is turned to secure it with respect to the post 2.

When the sleeve 3 is retrofitted over the post 2 as described, the trellis component 1 is ready for use. The process of retrofitting a sleeve 3 to a post 2 is repeated for the entire trellis row and for as many rows as desired. Alternatively the trellis component 1 can be assembled before being installed in a vineyard, rather than retrofitting.

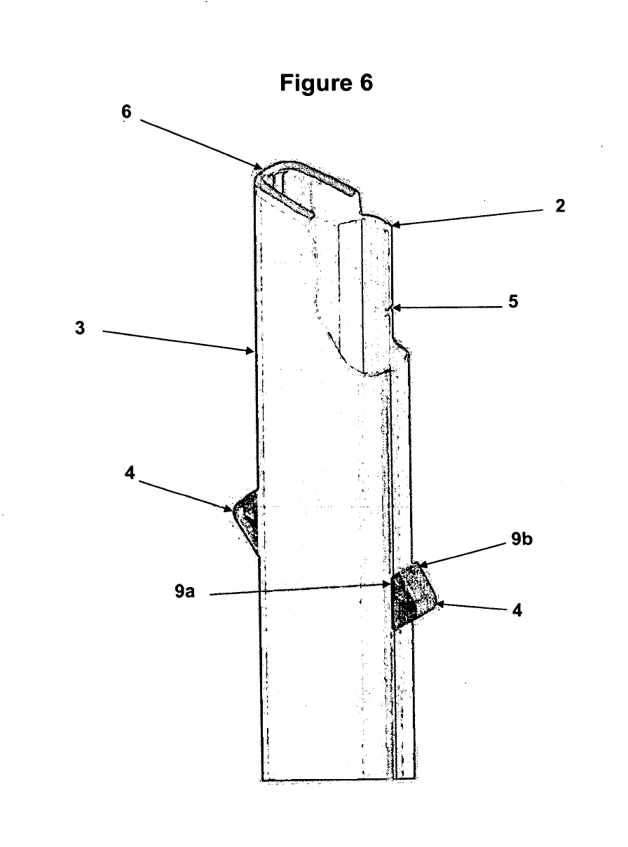

Referring to FIG. 6, the secured clip 4 is configured to receive a wire in a space between a pair of slightly resilient arms 9a, 9b. When grapes have been harvested and the vines are ready for pruning, the wire can be manually or mechanically removed from the clip by exerting upward pressure on the wire so that it is pulled out of the arms. The arms are such that they release the wire when it is subjected to at least a 20 kg upward force. The pin in the hole 7 assists in preventing the sleeve 3 from being removed from the post 2 when upward force is applied.

Vines that have grown around the wire can then be manually or mechanically cut and removed. In respect of the wire closest to the ground, and therefore closest to the roots of the grape vine, the vine may be severed before pruning. This is to avoid potential damage to the roots of the vine. The vine is severed at a suitable point above the roots but below the wire. The vine attached to the wire can then be cut and removed. When the vine has been pruned the wire can be placed between the arms 9a, 9b again by hand or by machine, ready for a new growing season.

While some preferred embodiments of the invention have been described by way of example it should be appreciated that modifications and improvements can occur without departing from the scope of the following claims.

What we claim is:

1. A method of growing grapes comprising the steps of:
a) fitting a plurality of longitudinal sleeves to posts, respectively, each sleeve having at least one retainer;
b) attaching at least two lines so that they are held by the retainers in an elevated disposition so that the lines at least partially support a grape vine;
c) mechanically removing the lines from the retainers after harvesting grapes, each sleeve being secured to its respective post by fixing means so that the sleeves remain fitted to the posts when the line is being mechanically removed;
d) pruning parts of the grape vine that remain with the lines when they are removed; and
e) reattaching the lines so that they are again held by the retainers in an elevated disposition for further use.

2. A method of growing grapes according to claim 1, wherein each fixing means is distinct from its respective post.

3. A method of growing grapes according to claim 1, wherein each fixing means comprises a fixing hole in each sleeve, and at least one fixing member arranged to pass through the hole and an opening in the post, to prevent the sleeve from being unintentionally removed upwardly from its corresponding post.

4. A method of growing grapes according to claim 1, wherein each sleeve has a plurality of the retainers.

5. A method of growing grapes according to claim 1, wherein the retainer, or each retainer as the case may be, comprises a clip.

6. A method of growing grapes according to claim 1, wherein the retainer, or each retainer, comprises upwardly extending resilient arms and the line held in a tension fit in a space between the arms.

7. A method of growing grapes according to claim 6, wherein the arms release grip on the line if the line is subjected to at least a 20 kg upward force.

8. A method of growing grapes according to claim 1, wherein the retainer, or each retainer as the case may be, is secured in an aperture of the sleeve.

9. A method of growing grapes according to claim 1, wherein each sleeve is substantially metallic, except for the retainer or retainers, which are substantially made of plastic.

10. A method of growing grapes according to claim 1, wherein the retainer, or each retainer as the case may be, is removable from each sleeve.

11. A method of growing grapes according to claim 1, wherein each line comprises wire.

12. A method of growing grapes according to claim 1, wherein each sleeve has a constricted upper region or an at least partially closed top to assist in retaining each sleeve at the desired height on its corresponding post.
